(19) United States
(12) Patent Application Publication
(10) Pub. No.: US 2015/0222157 A1
(43) Pub. Date: Aug. 6, 2015

(54) System for converting mechanical energy into electrical energy using tiles

(71) Applicants: Maria Mae Fleur Musa Villanueva, Quezon City (PH); Mark Francis Canlas de Leon, Quezon City (PH); Rene Laureste Toledo, JR., Marikina City (PH)

(72) Inventors: Maria Mae Fleur Musa Villanueva, Quezon City (PH); Mark Francis Canlas de Leon, Quezon City (PH); Rene Laureste Toledo, JR., Marikina City (PH)

(21) Appl. No.: 14/173,834

(22) Filed: Feb. 6, 2014

(51) Int. Cl. H02K 7/18

(52) U.S. Cl. CPC H02K 7/1853

(57) ABSTRACT

The invention disclosed is a system that converts mechanical energy into electrical energy from passing traffic on a floor unit. The system includes an assembly to convert the mechanical energy into electrical energy and a converter to regulate and store the electrical energy. The assembly generates electricity by converting both the upward and downward motion, received from passing traffic above the movable surface. The generated energy is stored in a dual-stage electrical energy storage device.

### BACKGROUND

Even after several decades, there is a constant pursuit in finding improved sustainable alternative sources of electrical energy to subsidize society's increasingly higher energy consumption. The most popular solutions include solar and wind energy.

One alternative energy source that has generated interest over the past couple of years has been the recycling or regeneration of unutilized energy from human motion. Although human motion has been previously used to generate electricity and activate gym equipment or send signals to video game dance mats, for example, the energy produced from these sources are minimal and limited to those devices. U.S. Pat. No. 7,432,607 (“'607 patent”) and U.S. Pat. No. 8,283,794 (“'794 patent”), as well as, US Patent Application 20130068047 (“'047 application”), are just some examples of patents and patent application that describe on harvesting energy from human motion.

Specifically, the '607 patent uses vibrational kinetic energy from the downward impulse of moving traffic to generate electricity from multiple dynamo cells. Each of the dynamo cells described in '607 has two electricity generating elements, such as coils, per cell. The '607 patent further discloses that the generated energy is stored to a storage device, such as a battery, but does not disclose how the generated energy is managed. The '794 patent describes a process of exerting a downward force on a dance floor module that causes a shaft of a dynamo to rotate and generate electricity. Although the dance floor module of the '794 patent discloses generating energy from a rebound motion, it does not disclose a full rotational motion and does not disclose a method for power management. The '047 application describes a translation of the downward displacement from traffic into rotational motion to drive the rotor of an electricity generator. However, the apparatus of '047 discloses only the use of a downward displacement of an upper depressible surface to engage the single motor in the apparatus described in the patent.

### SUMMARY

It is the object of the present invention to provide a system that converts a mechanical energy from traffic flow into an electrical energy. Specifically, it is the object of this invention to provide a system for generating, regulating, and storing the electrical energy harvested from the passage of traffic on a floor unit.

The system utilizes the floor unit having a movable surface for converting a downward motion into a rotational motion via a motion-translating member. The movable surface, which receives the downward motion from passing traffic, is attached to the motion-translating member. The movable surface may, at least partly, comprise an outwardly projecting or protruding button or an angled or a substantially flat surface.

The downward motion received by the movable surface is converted by a motion-translating member into a rotational motion of a synchronous motor shaft. The rotational motion corresponds to either a partial or a substantially full rotation of the synchronous motor shaft. But, a substantially full rotation of the synchronous motor shaft produces a larger generated alternating current. A subsequent upward motion due to the rebound of the movable surface after the passage of moving traffic is also utilized to produce rotational motion of the synchronous motor shaft.

At least one synchronous motor comprises line sources that are connected to a converter circuit. The converter circuit converts the alternating current into a constant value direct current.

The generated constant value direct current then passes through a dual-stage electrical energy storage device. The dual-stage electrical energy storage device comprises a first electrical energy storage device and a second electrical energy storage device. During a continuous motion above the floor unit, the first electrical energy storage device constantly charges up the second electrical energy storage device to a significantly larger capacity. Preferably, the second electrical energy storage device is utilized when the first electrical energy storage device has reached a threshold voltage.

### BRIEF DESCRIPTION OF THE DRAWINGS

FIG. 1 illustrates an isometric view representation of a preferred embodiment of a system for generating energy from passing traffic on a floor unit

FIG. 2 illustrates an exploded side view representation of a portion of a preferred embodiment of a system for generating energy from passing traffic on a floor unit.

FIG. 3A illustrates an isometric view of another embodiment of a system for generating energy from passing traffic on a floor unit.

FIG. 3B to 3D illustrate side views of other embodiments of a system for generating energy from passing traffic on a floor unit.

FIG. 4A illustrates a side view of a preferred embodiment of a system for generating energy from passing traffic on a floor unit.

FIG. 4B shows a magnified view of an element of a preferred embodiment of a system for generating energy from passing traffic on a floor unit.

FIG. 4C illustrates an alternative side view of a portion of a preferred embodiment of a system for generating energy from passing traffic on a floor unit.

FIG. 5A is a block diagram illustrating a preferred embodiment for converting a mechanical energy into an electrical energy generated from passing traffic on a floor unit.

FIG. 5B is a block diagram of the dual-stage electrical energy storage device of the preferred embodiment for converting a mechanical energy into an electrical energy generated from passing traffic on a floor unit.

FIG. 6 illustrates the storage compartment of a preferred embodiment of interconnected floor units.

FIG. 7 is a flowchart illustrating a preferred embodiment for converting a mechanical energy into electrical energy generated from passing traffic on a floor unit.

### DETAILED DESCRIPTION OF THE INVENTION

The present invention will now be described with reference to the drawings, wherein like reference numerals are used to refer to like elements.

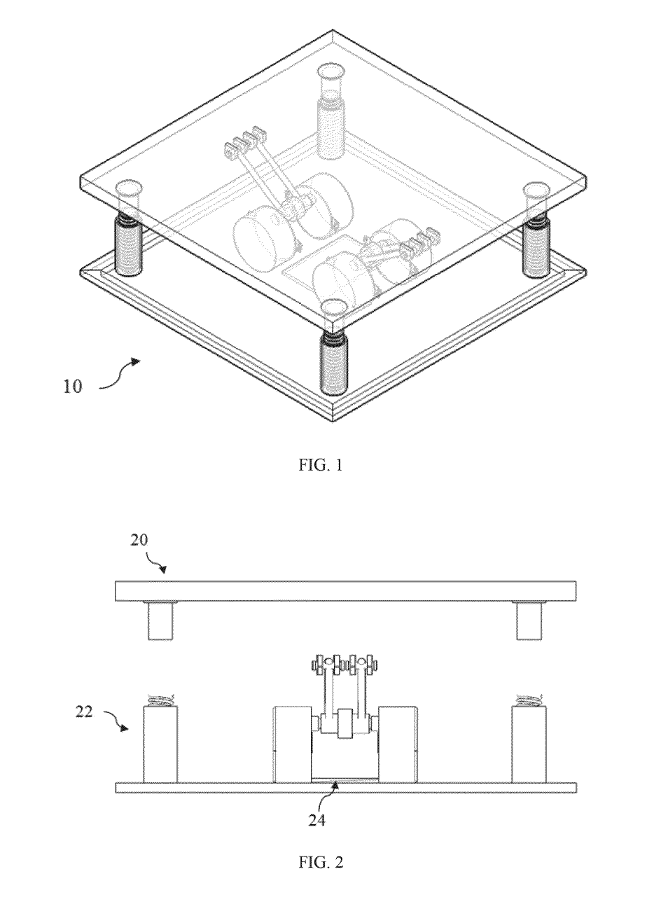

FIG. 1 shows an embodiment comprising a floor unit (10) for converting a mechanical energy into an electrical energy. FIG. 2 shows a preferred embodiment of the invention that provides the floor unit comprising a surface (20) and a bottom assembly (22). The surface (20) is movable and the bottom assembly (22) comprises a set of mechanical components and a converter circuit (24). Most preferably, the floor unit is similar in dimension to conventional flooring tiles, e.g., a 10 cm×10 cm square tile. Preferably, the floor unit is of a polygonal shape, including but not limited to a square or a rectangle, or any combination of different shapes. Preferably, the movable surface (20) is at least 10 mm in thickness. The movable surface (20) may be made of any material commonly used for conventional flooring tiles, e.g., wood, metal, stone, ceramic tiles, or a composite of those materials. Further, the floor unit is preferably installed in public areas with high traffic volume such as sidewalks, malls and offices. In a preferred embodiment, the movable surface is substantially flat.

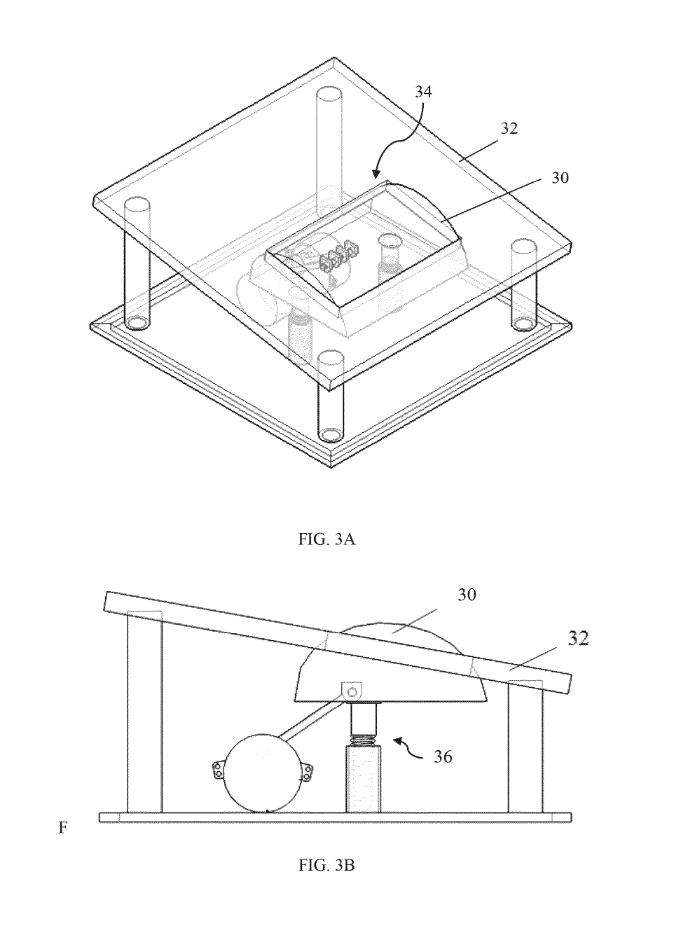

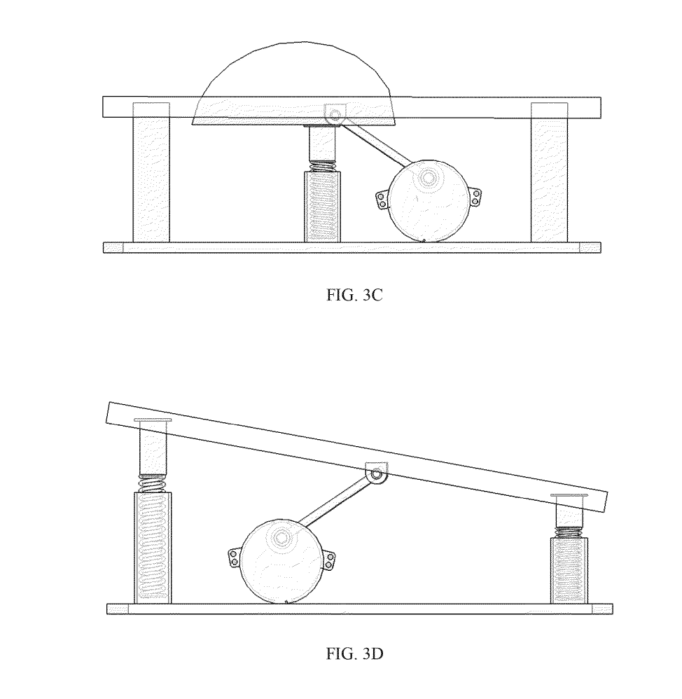

FIG. 3A to 3C show a movable surface in accordance with the invention, wherein the movable surface may, at least partly, comprise an outwardly projecting or protruding button (30), or an angled surface (32). In the case of an outwardly projecting button (30), it is most preferably of a domed configuration. More preferably, the outwardly projecting button (30) has a curved profile. Preferably, the outwardly projecting button (30) has a substantially flat profile. In a preferred embodiment, the highest point of the outwardly projecting button (30) projects out to a height of about 10 mm from a surface of a tile. Most preferably, the outwardly projecting button (30) projects out above and partially extends underneath the tile through a tile aperture (34). In a preferred embodiment, the tile aperture (34) is equivalent to at least about 25% of the tile area. It is preferred that the tile aperture (34) is in the middle of the tile. FIG. 3D shows the case of the movable surface being an angled surface (32), wherein the angled surface is functionally equivalent to a substantially flat surface.

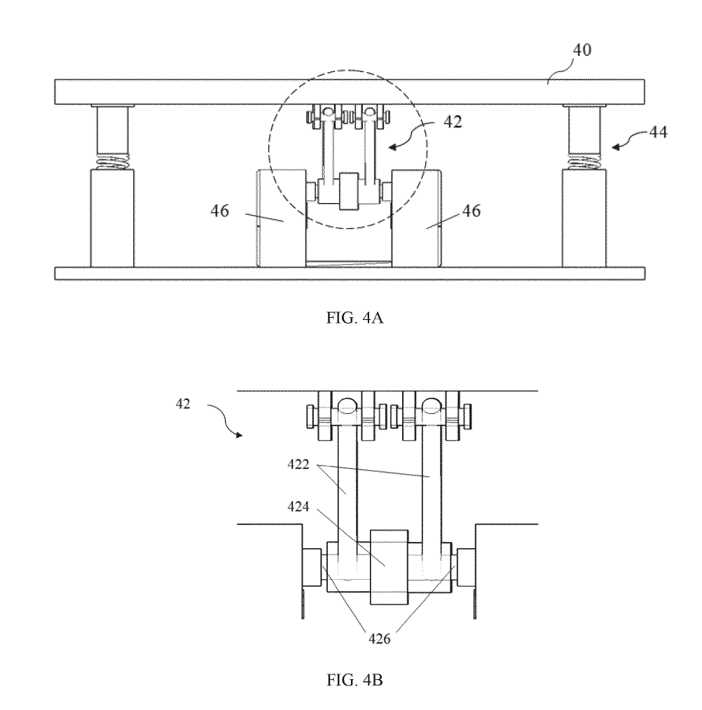

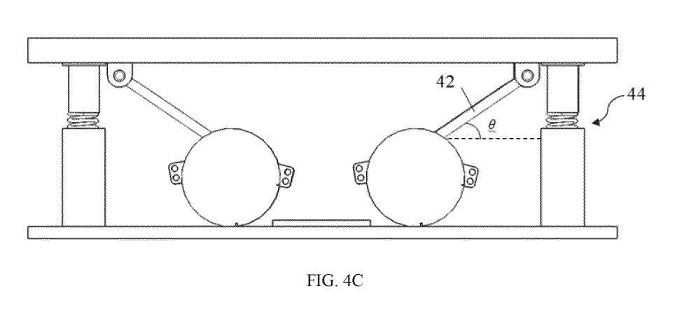

FIG. 4A shows a floor unit with a movable surface connected to a motion-translating member that converts a downward motion into a rotational motion. The motion-translating member comprises an angled pull member (42) and at least one spring element (44). FIG. 4B shows the magnified view of the angled pull member (42). Preferably, the angled pull member (42) is secured to the movable surface through a pull rod (422). Preferably, a coupling pivot (424) lies between and couples the pull rod (422) and at least two synchronous motor shafts (426). Here, the angled pull member and the movable surface undergo simultaneous displacement. FIG. 4C shows an angular displacement of the angled pull member (42), which is preferably less than about 90°, more preferably between about 20° and about 45°. Preferably, the direction of the angular displacement of the angled pull member (42) is substantially perpendicular to the movable surface. The motion-translating member is preferably made of stainless steel but other materials may be used in accordance with the invention.

The received downward motion is converted into a rotational motion by the motion-translating member through the rotation of the at least one synchronous motor shaft. The rotational motion of the synchronous motor shaft, which is most preferably a substantially full rotation of at least about 300°, more preferably a partial rotation between about 45° and about 300°, and preferably a minimal rotation of not greater than about 45°, is completed for every received downward motion. In a preferred embodiment, only the downward motion is utilized to produce the rotational motion of the synchronous motor shaft. The rotation of the synchronous motor shaft generates an alternating current. Most preferably, the substantially full rotation of the synchronous motor shaft produces the largest generated alternating current. Most preferably, a subsequent upward motion due to the rebound of the movable surface, which is generated after the passage of traffic, is also used to generate the rotational motion of the synchronous motor shaft. FIG. 4A shows a preferred embodiment of the invention, wherein the upward motion of the movable surface is provided by the motion-translating member through at least one spring element (44). Most preferably, the spring element comprises a coil spring preferably encased by a supporting rigid column. Preferably there is at least one spring element positioned at each floor unit corner. FIG. 3B to 3C show a preferred embodiment of the floor unit with the outwardly projecting button, wherein there is at least one spring element (36) underneath the outwardly projecting button. Other embodiments of the spring element may be devised by those skilled in the art without departing from the scope of the invention.

In accordance with the invention, the magnitude of the generated alternating current from the upward motion of the surface is substantially equivalent to the generated alternating current from the downward motion. Most preferably, the magnitude of the generated alternating current from the upward motion is equivalent to at least 90% of the generated alternating current from the downward motion. The floor unit may also generate alternating current even if the surface has yet to rebound to its highest position. The generated alternating current from both the downward and upward motion is especially advantageous in high volume traffic areas where there is continuous motion above the floor unit, thus allowing sustained electrical generation, harvest, and storage.

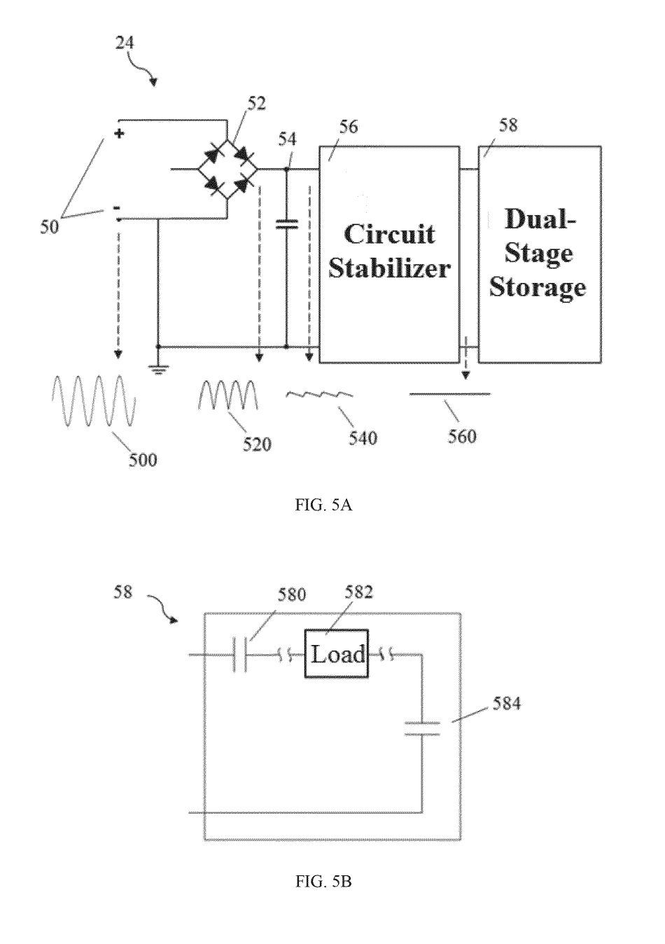

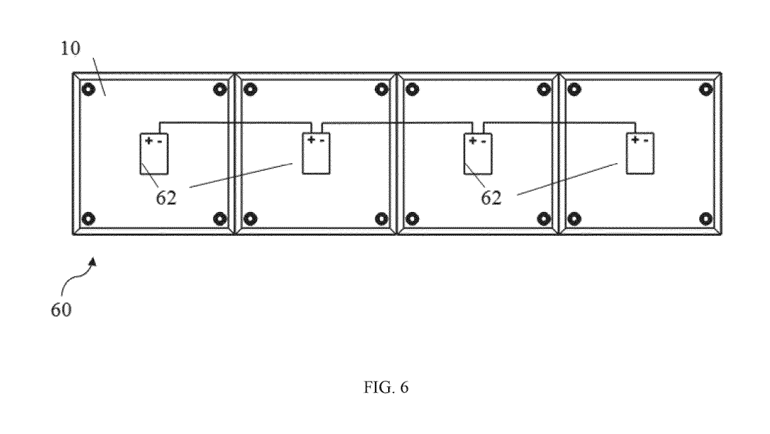

FIG. 5A shows a most preferred embodiment wherein the synchronous motors comprise line sources (50) that are connected in-parallel to the converter circuit (24). Preferably, every rotation of the synchronous motor shaft generates an alternating current (500) comprising both positive and negative half-cycles. Both the positive and negative half-cycle pass through a full-wave bridge rectifier, wherein the full-wave bridge rectifier retains the positive half-cycles and transforms the negative half-cycles to equivalent positive half-cycles (52). The resulting positive pulsating signal (520), which comprises combined positive half-cycles and positively-transformed half-cycles, passes through a capacitor, to smoothen the positive pulsating signal. In accordance with the invention, the smoothened pulsating signal (540) then passes through a regulator (56) to generate a constant value direct current (560).

Next, the generated constant value direct current passes through a dual-stage electrical energy storage device (58) that comprises a first and second electrical energy storage device, wherein the first electrical energy storage device (580) is charged at a relatively low capacity, e.g., 20V. FIG. 5B shows an embodiment of the invention wherein the first electrical energy storage device acts as an active switch for any load or device (582) to allow for immediate energy usage. The energy generated at this stage would be sufficient to support any attached load or device (582) operating within the relatively lower first electrical energy storage device capacity e.g., less than 5V.

Preferably, the dual-stage electrical energy storage device further comprises a second electrical energy storage device (584) that is serially connected to the first electrical energy storage device (580). Preferably, the second electrical energy storage device begins charging when the first electrical energy storage device reaches a threshold voltage, V_{TH}, e.g., 25% of a given capacity of the first electrical energy storage device.

During a continuous motion of the floor unit from a constant traffic flow, the second electrical energy storage device would be charged to a significantly larger capacity, e.g., 105V, by the first electrical energy storage device. When there is minimal movement of the floor unit, the first electrical energy storage device gradually decreases in capacity, which can become insufficient to supply energy to a load. The second electrical energy storage device, with 10% charge of the maximum capacity, preferably supplies a forward current to the first electrical energy storage device in case a voltage drop occurs. This allows consistent energy supply to the load.

More preferably, each of the first and second electrical energy storage device is a battery. Alternatively, each of the first and second electrical energy storage device is a capacitor.

FIG. 6 is an arrangement of multiple floor units (60) connected in series (62). Various other arrangements of multiple floor units are also possible in accordance to the invention.

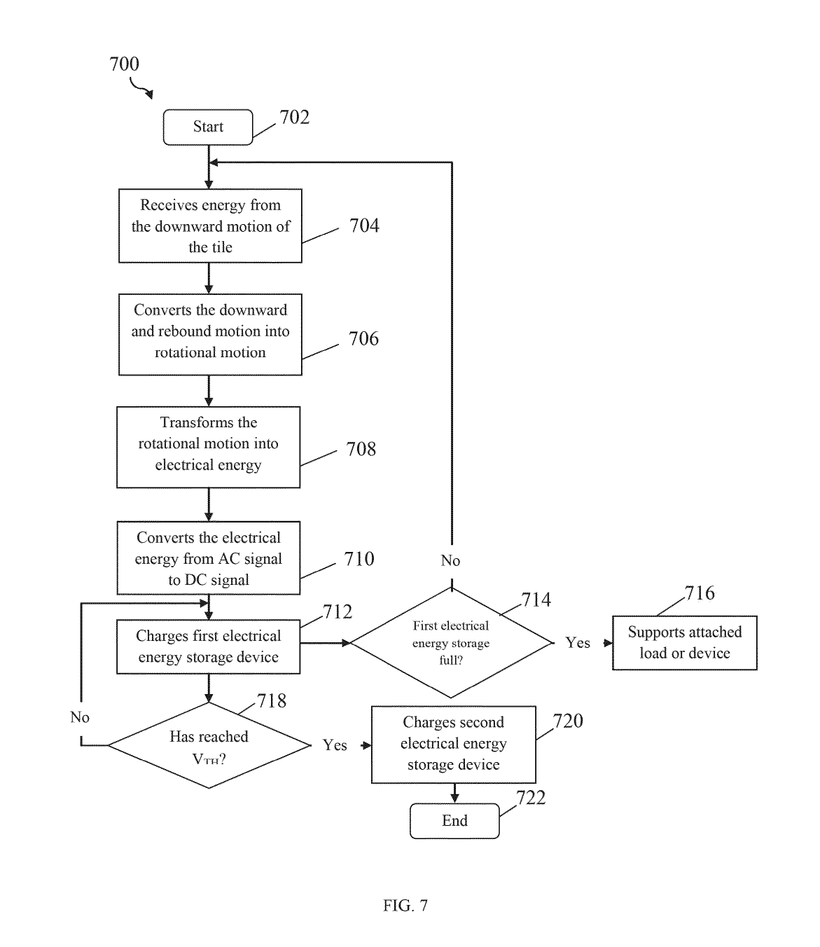

FIG. 7 is a flowchart illustrating a process of a mechanical energy to an electrical energy conversion in accordance with the invention. The conversion process begins when a user steps on a floor unit (702) having a movable surface. As the movable surface moves downward (704) as a result of the received motion, the motion-translating member is then enabled. Consequently, the motion-translating member, which is connected to at least one synchronous motor shafts, causes it to undergo rotation (706). Thereupon, the rotation of the synchronous motor shafts generates an alternating current (708).

Next, a converter circuit converts the generated alternating current into a constant value direct current (710). The constant value direct current charges up a first electrical energy storage device (712) up to or near its full capacity (714), which can then be used to support any attached load or device (716). After the first electrical energy storage device reaches a threshold voltage, V_{TH} (718), the second electrical energy storage device begins charging. Once the full capacity of electrical charge has been achieved (720), the conversion process is complete (722).

Other embodiments of the present invention may be devised by those skilled in the art without departing from the scope of the invention.

1. A system for generating electrical energy from mechanical energy, comprising:
a movable surface that receives an energy input via a downward motion from a passing traffic;
a motion-translating member that converts the downward motion into a rotational motion; and
at least one synchronous motor that converts a mechanical energy generated by the rotational motion into an electrical energy.

2. The system of claim 1, wherein the movable surface rebounds to produce an upward motion following the downward motion.

3. The system of claim 2, wherein the motion-translating member converts the upward motion into rotational motion.

4. The system of claim 1, wherein the movable surface is a substantially flat surface.

5. The system of claim 1, wherein the movable surface is an upwardly projecting button.

6. The system of claim 1, wherein the rotational motion arises from a rotation of a synchronous motor shaft.

7. The system of claim 6, wherein the rotation of the synchronous motor shaft is greater than about 300°.

8. The system of claim 6, wherein an alternating current is generated from the rotation of the synchronous motor shaft.

9. The system of claim 1, wherein the motion-translating member further comprises
an angled pull member having one end connected to the synchronous motor shaft and another end connected to the movable surface; and
at least one spring element.

10. The system of claim 1, further comprising at least two interconnected floor units.

11. The system of claim 11, wherein an angular displacement of the angled pull member ranges between about 20 to about 45 degrees.

12. A floor unit comprising,
a movable surface that receives an energy input via a downward motion from a passing traffic, wherein the movable surface rebounds to produce an upward motion following the downward motion;
a motion-translating member that converts both the downward and the upward motion into a rotational motion;
a converter circuit; and
at least one synchronous motor that converts the rotational motion into an electrical energy.

13. The floor unit of claim 12, wherein both the downward and the upward motion of the movable surface generates an alternating current having a positive and a negative half-cycle.

14. The floor unit of claim 12, wherein the converter circuit converts the alternating current into a direct current.

15. The floor unit of claim 12, wherein the electrical energy is stored in a dual-stage electrical energy storage device.

16. The floor unit of claim 15, wherein the dual-stage electrical energy storage device comprises a first and a second electrical energy storage device.

17. The floor unit of claim 16, wherein the first electrical energy storage device supplies a forward current to the second electrical energy storage device.

18. The floor unit of claim 16, wherein the second electrical energy storage device supplies a forward current to the first electrical energy storage device.

19. The floor unit of claim 16, wherein the forward current is supplied to the first electrical energy storage device when there is no passing traffic.

20. A process of generating electrical energy from mechanical energy comprising the steps of:
receiving an energy input from passing traffic through a movable surface;
converting a downward and an upward motion into a rotational motion of a motion-translating member;
transforming a mechanical energy from the rotational motion into an electrical energy via a synchronous motor; and
storing the electrical energy in a dual-stage electrical energy storage device.
